(19) United States
(12) Patent Application Publication
(10) Pub. No.: US 2015/0310745 A1
(43) Pub. Date: Oct. 29, 2015

(54) METHOD AND APPARATUS FOR LOCATING VACANT PARKING LOCATIONS IN A PARKING LOT OR STRUCTURE

(71) Applicant: The Taubman Company LLC, Bloomfield Hills, MI (US)

(72) Inventor: Michael Osment, Bloomfield Hills, MI (US)

(21) Appl. No.: 14/693,018

(22) Filed: Apr. 22, 2015

Related U.S. Application Data
(60) Provisional application No. 61/983,702, filed on Apr. 24, 2014.

(51) Int. Cl. G08G 1/14; H04N 7/18

(52) U.S. Cl. CPC G08G 1/141; H04N 7/181

(57) ABSTRACT

A method and system for advising drivers in a parking lot or structure arranged with rows of parking spaces as to the availability of vacant parking spaces in each row comprising a plurality of cameras for imaging the parking spaces, a computer which receives the output of the camera and analyzes the output to detect vacant parking spaces, and signal devices visible to drivers of vehicles seeking vacant parking spaces adjoining each of the rows of the parking spaces operative to be controlled by the computer to indicate the availability of vacant parking spaces.

### CROSS-REFERENCE TO RELATED APPLICATIONS

This application claims priority of U.S. Provisional Application 61/983,702 filed Apr. 24, 2014, the contents of which are incorporated herein by reference.

### FIELD OF THE INVENTION

This invention relates to the problem of providing vehicle drivers seeking to park in a parking lot or parking structure information as to the location of vacant parking spaces in the structure.

### BACKGROUND OF THE INVENTION

Drivers seeking vacant parking spots in crowded or full parking lots or parking structures are often frustrated by their need to waste time and fuel, and contribute to the pollution of the atmosphere, by cruising the rows of the lot or structure to find an empty parking space. This has given rise to two classes of solution. One involves building sensors for detecting the presence of a vehicle in each parking spot which are all connected to a central display panel visible to the drivers. This is an expensive solution and the sensors are difficult to install in existing parking areas without disrupting the normal parking function.

Another solution has been to detect vacant parking spots by use of cameras scanning the parking areas which then communicate the location of empty parking spots to cell phones carried by the drivers and equipped with apps which put their cell phones in communication with the vacant spot detector. However, some drivers do not carry smart cell phones and it is difficult to persuade all drivers who do and utilize the parking areas to adopt the apps. Moreover, the driver distraction occasioned by requiring them to use their cell phones while looking for a spot creates safety problems.

### SUMMARY OF THE INVENTION

Accordingly, the present invention is directed toward a vacant parking space locator for a parking lot or structure which is low in cost to install; does not require a driver to possess a cell phone, let alone a cell phone with a particular app; and which provides the vacant spot information without distracting the driver's attention from controlling the vehicle.

Broadly, the present invention utilizes CCTV optical detectors or the like, mounted on elevated supports, to detect the unoccupied parking spaces as well as changes in the space occupancy on a real-time basis, such as within a relatively few seconds, and provides display devices associated with each row of a parking lot or structure which indicate the presence of a vacant spot in that row. By further detecting vehicles moving toward vacant spaces and previously parked vehicles leaving each row, the system very accurately tracks the information needed for drivers to locate vacant spots on a real-time basis.

Accordingly, this combination of features provides a vacant parking identification system that is low in installed cost, can easily be installed in existing parking lots and structures, and provides the vacant spot information to all drivers in a manner which does not distract them from the driving task.

In a preferred embodiment of the invention, which will be subsequently disclosed in detail, a relatively small number of CCTV cameras or the like may be supported at heights above the parking lots or structure on towers or the like, to generate signals from which vacant parking spaces can be detected. Driver visible signals, which may be as simple as green or red lights indicating the availability or non-availability of vacant parking spaces in the adjacent row, are disposed at one or both ends of each parking row. The CCTV cameras provide their outputs, either in a wired or wireless manner, to a computer server which analyzes the data from the cameras based on the empty spaces noted by the cameras and the detection of cars pulling out of a parking spot or entering a row with a vacant parking spot. Based on this data the server determines availability of at least a minimum number of parking spots in each row, such as one or two. If the availability is at or above that predetermined number, a green signal light will be energized at each end of the adjacent row. If the availability is less than that threshold value, the server will change the light from green to red.

Preferably, at some time when the lot should be empty of cars, such as early in the morning, the server purges the database of space availability data and the parking spaces as identified in the database are later indicated as filled as the lot or structure row begins to fill.

The system preferably includes the capability of determining the availability when the parking gridlines on the floors of the lot or structure are obscured, as by snow or the like, or when a vehicle is parked across rather than within the gridlines, by determining whether there is sufficient space available in the partially blocked space to allow a car to park.

The system uses the baseline locations determined when the lot is empty as a reference and marks each available space with coordinates, such as latitude/longitude, or the space's relation to a common reference point in the lot or structure. The server quickly counts the number of vacant spaces (or occupied spaces) in each row and detects cars moving toward or away from an available space to determine the number of spaces available and control the signals.

### BRIEF DESCRIPTION OF THE DRAWINGS

Other objectives, advantages, and applications of the present invention will be made apparent with reference to the accompanying drawings in which:

FIG. 1 is a schematic representation of a preferred embodiment of the present invention; and

FIG. 2 is a top view of the embodiment of FIG. 1 as applied to a parking lot.

### DETAILED DESCRIPTION OF THE PREFERRED EMBODIMENT OF THE INVENTION

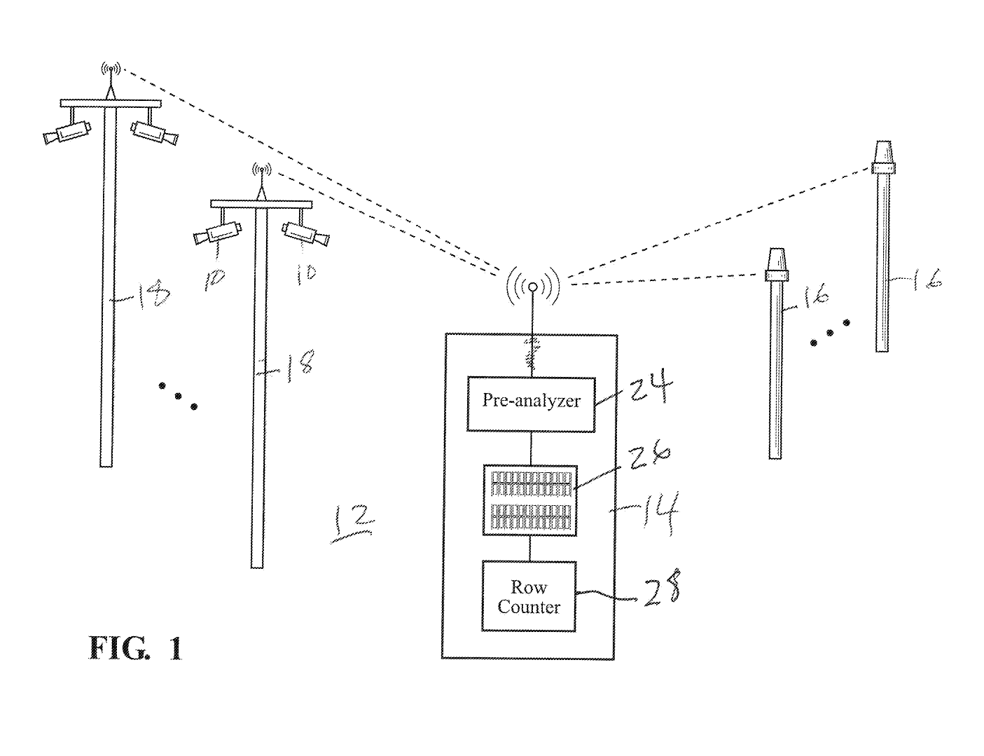

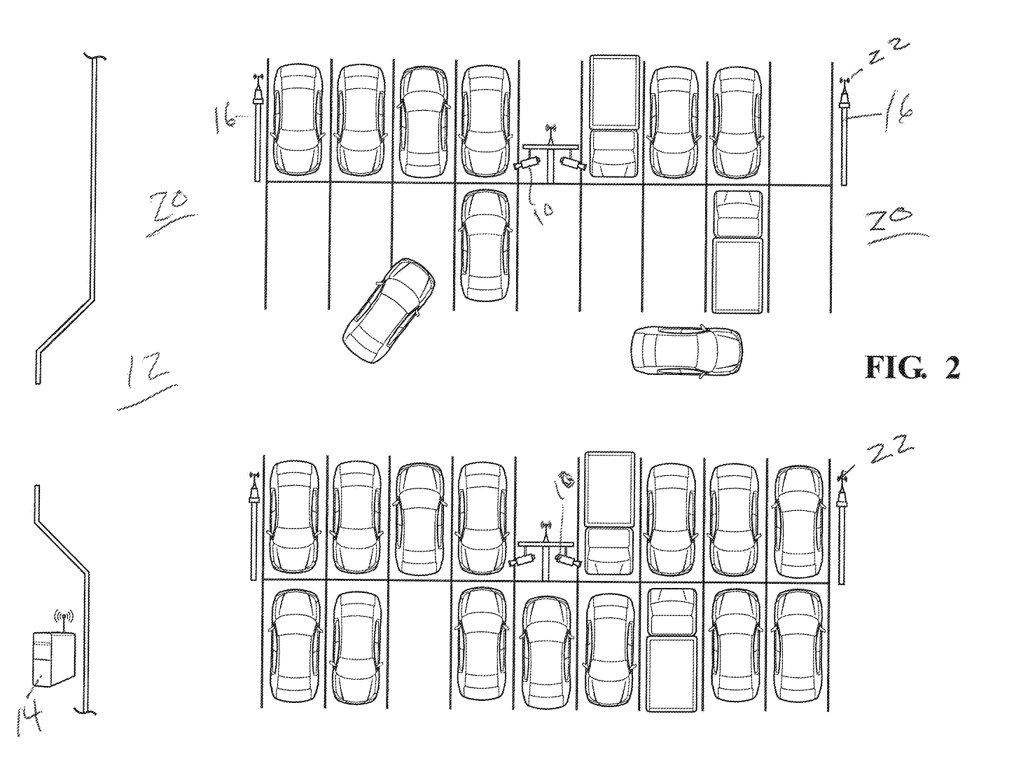

The preferred embodiment of the system illustrated in FIGS. 1 and 2 and exemplifying the method of the present invention, broadly has three elements: a plurality of cameras 10 supported above the parking lot or structure 12 operative to image each of the parking spaces; a computer 14 operative to receive the output of the cameras either in a wireless manner as illustrated, or in a wired manner, and operative to analyze the camera data to detect vacant parking spaces; and signal indicators 16 visible to drivers seeking parking spaces, indicating those rows in which parking spaces are available.

The cameras 10 are preferably supported on poles 18 or from the ceiling of a structure at a sufficient height above the parking lot or structure 12 so that they capture images of all of the parking spaces in the lot or structure 12. The cameras 10 may be responsive to visual light or infrared light, or some combination of both. This will allow the cameras to continue imaging the structure during times when there may not be sufficient light within the structure to illuminate each of the parking spaces. The poles 18 are arrayed such that each parking space in the lot or structure may be imaged.

The images captured by the cameras 10 are communicated to the computer 14 either wirelessly or by cables. Use of wireless connections simplifies the installation of the present system in existing parking structures without disruptive construction.

The third element of the inventive system is signal devices 16 which are visible to drivers of the vehicles in the lot or structure seeking vacant parking spaces. As illustrated in FIG. 2, the signal devices 16 may be located in aisles of the lot or structure through which the drivers travel in viewing the rows of the parking structure. The signal devices are preferably disposed at either one or both ends of each of the rows of parking spaces adjacent the aisles 20 so that a driver in a vehicle moving through the aisles 20 will readily observe the signal devices 16.

In their simplest form the signal devices may simply carry a pair of lights 22 at their upper ends, which may be alternatively energized by signals from the computer 14 sent either wirelessly or through appropriate wired connections. One of the signal lights 22 may be red and the other green, with the green light indicating that there are parking vacancies in the adjoining parking row and preferably a predetermined minimum number of vacancies such as one, two, or three. With that minimum number of vacancies the green light may be energized, and in the absence of that number of vacancies the red light is energized.

In alternate embodiments of the signal lights 16, they may take the form of computer displays which could carry other information beyond the availability or non-availability of parking vacancies in the accompanying rows. For example, they might carry information about the associated structure which may be a shopping mall or the like, such as its hours of operation, special sales, or even advertisements. The signal devices need not be supported on poles but could be suspended from the ceiling of parking structures.

As indicated in FIG. 1, the computer 14, which receives the signals from the imaging devices 10 and generates control signals for the signal devices 16, preferably contains a program with three general structures. Cameras 10 are provided wirelessly or through wired connection to the computer 14. The computer 14 feeds the CCTV signals first to a program section 24 constituting a pre-analyzer which extracts information for each parking space from the CCTV signals. The pre-analyzer determines which of the parking spaces contains a vehicle and which are vacant or sufficiently vacant, possibly obstructed by snow or the like, to accommodate a vehicle. The pre-analyzer section of the program may also detect vehicles pulling out of parking spaces or entering rows with empty parking spaces. On this basis an analysis of whether each parking space is free or occupied is sent to a program section 26 constituting a database of the vacant parking structures. The database 26 is then analyzed by a row counter 28, which determine the number of vacant parking spaces in each row.

Preferably, this information is modified by additional information which may be extracted from the CCTV scans. For example, when the CCTV detects a car turning into an aisle it recalculates the availability of spaces including that new car on the assumption that the car is seeking a vacant parking space and will occupy it.

Similarly, when the CCTV detects a vehicle in the aisle 20 moving away from an open parking spot, that availability is added to the database and the number of spaces and rows are recalculated.

The program further analyzes the outputs of the CCTV cameras at some time when the lot is known to be empty, such as early in the morning, long after the associated business structure has closed and before the business structure is open for business, such as 2:00 or 3:00 a.m. At that time the database is purged of signals representing occupied or partially occupied parking spaces. Thereafter, fresh scans from the CCTV cameras update each parking space located in the database for availability, using the grid of parking lines on the floor of the lot or structure to determine space count and location.

Each row in the database is identified with a reference number as to the position of that space. The reference may be the latitude and longitude of the space as determined from a drawing of the parking lot or any reference with respect to a fixed point in the lot or structure. The row counter quickly determines the change in the count of the number of occupied spaces. This count is compared to the total available in that row and the availability variable is updated.

When the parking gridlines are obscured the system does an additional check. From the parking lot image it calculates the size of an available space with the gridlines blocked based on the number of pixels horizontally and vertically. If the size of the space is below a system-set threshold, the space is marked as unavailable and the database is updated.

If availability of vacant parking spots in a row drops below a threshold setting, such as one or two vacancies, the signal devices 16 for the associated row are switched from green to red. If availability rises above the threshold setting after a scan, the light is changed from red to green.

Accordingly, in use, a driver of a vehicle seeking an open parking space approaches the parking lot on an aisle 20 and the driver picks a parking aisle with a green light or the like energized on the display devices 16 and then proceeds to the parking spot and parks. The CCTV detects the car turning into the aisle and reduces the availability of vacant spaces in the count of that row.

Particularly when the communication between the cameras 10 and the display devices 16 and the computer 14 is wireless, there is a very low cost of implementation of the present system in either a lot or structure under construction or in a preexisting lot or structure. Use of the system requires no particular education of the driver except for the need to find a row with a green signal device 16 at the row end.

The system speeds the parking process and greatly reduces driver frustration required with conventional systems.

Having thus described my invention, I claim:

1. A system for advising drivers in a parking lot or structure arranged with rows of parking spaces as to the availability of vacant parking spaces in each row, comprising:
a plurality of cameras supported above the parking spaces of such lot or structure and imaging each space;
signal devices visible to drivers of vehicles seeking vacant parking spaces disposed adjoining each of the rows of parking spaces, operative to indicate the availability of vacant parking spaces in each adjoining row; and
a computer connected to receive signals from each of said cameras and operative to control the state of the displays to indicate the availability of vacant parking spaces in each row adjoining a signaling device, the computer comprising a database of the parking spaces in each row of the lot or structure with an indication of availability of each space at a given time and being operative to generate control signals for said signal devices to indicate the vacancy of a number of parking spaces above a preset minimum in the associated row by the condition of said adjoining signal device.

2. The system of claim 1, wherein the communication between each of the signal devices and the computer is wireless.

3. The system of claim 1, wherein said signal devices comprise lights visible to the drivers of vehicles seeking vacant parking spots, with a light of a first color indicating the availability of vacant parking spaces in the row adjoining each signal device and a light of a second color indicating the non-availability of vacant parking spaces in the row adjoining said signal device.

4. The system of claim 3, wherein the light indicating the availability of vacant parking spaces in the row adjoining a signaling device indicates the availability when a predetermined minimum number of vacant parking spaces are available and otherwise the light indicating the non-availability of parking spaces is energized.

5. The system of claim 1, wherein the cameras image infrared light.

6. The system of claim 1, wherein the computer comprises a program which analyzes the signals from each of the video cameras to identify parking spaces occupied by vehicles.

7. The system of claim 6, wherein the computer program further comprises means for creating a database of each of the parking spaces with indications of which are occupied by vehicles or unoccupied.

8. The computer system of claim 7, wherein the computer program further comprises a means for counting the number of parking spaces in each row of the database and uses this information to control said signal devices.

9. The system of claim 8, wherein the communication between the computer and the signal devices is wireless.

10. A system for advising drivers in a parking lot or structure arranged with rows of parking spaces as to the availability of vacant parking spaces in each row, comprising:
a plurality of video cameras supported above the parking spaces of such lot or structure and imaging each space;
signal devices each comprising a pair of lights of differing color, one of which is energized when a space is vacant and another of which is energized when a space is occupied by a vehicle, the signal devices being disposed adjoining each of the rows of the parking spaces and being visible to drivers of vehicles seeking vacant parking spaces operative to indicate the availability of vacant parking spaces in each adjoining row;
a computer connected to receive signals from each of said video cameras, to analyze said signals to determine which of the parking spaces are occupied and which are unoccupied; and
a database forming part of the computer and having a signal storage area for each parking space with an indication of whether the parking space is occupied or unoccupied by a vehicle, operative to generate control signals for said signal devices to indicate the vacancy of a number of parking spaces above a preset minimum, by the condition of said adjoining signal device.

11. The system of claim 10, wherein the computer includes programming for counting the number of unoccupied parking spaces in each row identified in the database, to generate control signals for said signal devices.
